(19) United States
(12) Patent Application Publication
(10) Pub. No.: US 2025/0271828 A1
(43) Pub. Date: Aug. 28, 2025

(54) PROCESS IMAGE WITH CHANGE TRACKING FOR EVENT-BASED OPERATION OF AUTOMATION DEVICES

(71) Applicant: WAGO Verwaltungsgesellschaft mbH, Minden (DE)

(72) Inventor: Daniel JEROLM, Bad Essen (DE)

(73) Assignee: WAGO Verwaltungsgesellschaft mbH, Minden (DE)

(21) Appl. No.: 19/065,812

(22) Filed: Feb. 27, 2025

(30) Foreign Application Priority Data
Feb. 27, 2024 (DE) 10 2024 105 516.2

(51) Int. Cl. G05B 19/042

(52) U.S. Cl. CPC G05B 19/0426; G05B 2219/25011

(57) ABSTRACT

A method, apparatus, and computer programs for event-based operation of a programmable automation device, the method comprising: receiving a change notification indicating a changed value of an input of the automation device. A data point of an input process image of the automation device assigned to the input is updated based on the changed value. A change indicator of the data point of the input process image is set, which indicates that the data point has been updated. The invention enables more performance results with considerable resource savings (especially consumption of electrical energy), especially in fields of application with only rare changes to control data and/or changes to the control data on only a small scale.

This nonprovisional application claims priority under 35 U.S.C. § 119(a) to German Patent Application No. 10 2024 105 516.2, which was filed in Germany on Feb. 27, 2024, and which is herein incorporated by reference.

### BACKGROUND OF THE INVENTION

### Field of the Invention

The present invention relates generally to the technical field of automation technology, in particular building automation. It particularly relates to automation devices which determine output signals based on specific input signals and, for example, a control program and which output or provide these output signals.

### Description of the Background Art

In the technical field referred to above, control systems with programmable logic controllers (PLCs) are often used, which directly or implicitly have at least one input process image and one output process image. An input process image typically represents the actual state, whereas the output process image represents the target state. A controller maps the input process image to the output process image.

In this context, a control program is often executed cyclically, in particular regularly, for example at fixed time intervals or cycle durations. This keeps the output process image “up to date”. The cyclic execution therefore serves to ensure that the output process image embodies the actual current target state of a system, without causing unnecessary delays in system operation.

Often, this involves iterating over all input data, each time per cycle. All output data is recalculated and may then need to be transmitted via communication buses, which costs valuable bandwidth. The execution of the complete control programs consumes valuable (constant) energy in each cycle step.

The synchronization achieved in this way therefore depends on a lot of energy and extensive resources (electrical energy, memory, bandwidth, CPU power) in the state of the art, which are not always available, particularly in the field.

Another disadvantage is that the response time of the system is limited by the cycle duration. Often, there are synchronization requirements and synchronization issues (e.g., between several cooperating subsystems). Such problems can even lead to faulty and/or unpredictable system behavior.

A further problem is that in particular short-term state changes on the input side remain completely undetected and are therefore not taken into account on the output side if the cycle duration is too long in relation to the duration of the state change.

### SUMMARY OF THE INVENTION

It is therefore an object of the present invention to provide a resource-and energy-saving and at the same time effective and expedient solution for the operation of automation devices and thus to at least partially avoid the aforementioned disadvantages.

In its most general form, the present invention provides methods, apparatus, systems, and computer programs for event-based operation of a programmable automation device. The methods described may be computer-implemented.

According to an aspect of the present invention, a method for event-based operation of a programmable automation device may be provided. The method may include receiving a change notification. The change notification may indicate a changed value of an input of the automation device. The method may include updating a data point of an input process image of the automation device which is assigned to the input. This may be based on the changed value. The method may include setting a change indicator (“change flag”) of the data point of the input process image. The change indicator may indicate that the data point has been updated. The change indicator may be set, for example, when the data point has been updated, in particular to show that the data point has been updated. For example, the change indicator may only be set if the data point has been updated, and not otherwise.

The change indicator allows, in particular, for further data processing steps (e.g., of a control program) to only be executed if the change indicator is set. Furthermore, the change indicator enables, for example, only parts of further data processing steps (e.g., of a control program) to be executed which depend on input values for which a change indicator is set positive. This conserves valuable resources which are often only available to a limited extent in the field and reduces energy consumption. The non-cyclical, but instead event-driven approach saves resources. Furthermore, the response time of the system is not limited by the cycle duration. A complex synchronization of cycle start and end, which is otherwise essential for deterministic results, is no longer necessary.

In addition, it may be contemplated that a change indicator remains set even if a state is only changed temporarily for a short period of time; for example, if a value is set from a value x to a value y and shortly afterwards reset back to value x (possibly with intermediate values in between). The control may then take into account the set positive change indicator. This also allows for short-term changes in the input process image to be detected, especially those that might otherwise remain completely hidden within an “update cycle”.

The change indicator may therefore remain set (in the input and/or output process image) if a value of a data point is reset to a previous value. In particular, this may also be the (“one”) original value, in particular an old value which the data point had at a (last) start of the control program (in the case of the output process image) or at a (last) start of the processing of incoming change notifications (in the case of the input process image). The processing of incoming change notifications preferably takes place when the control program is not executed. Processing of incoming change notifications may be started when a (partial) execution of the control program has ended, i.e., has been completed.

This provides for more precise and resource-efficient control. In addition, it may be responded to individual events more quickly (sometimes by a factor of 10 or more compared to the cyclical approach). The invention therefore not only allows for conserving resources but is also more efficient in relation to its intended use.

This is particularly the case for applications where no digital signal processing in the narrow sense is carried out, but where the data changes (event-based) rarely and only to a small extent.

An exemplary sequence of steps of a method according to an example of the present invention will be described in more detail with reference to FIGS. 2-10.

A control program may either be an integral part of the firmware or, in particular, may be created by the user of the device and/or stored in the device.

The automation device may communicate on both, the input side and/or the output side, through change notifications. Such change notifications may be stored, especially on the input side, in a FIFO queue for later processing, for example while a control program is still being executed, to guarantee a smooth process. During processing, incoming change notifications are then entered into an input process image of the automation device. The input process image may be organized in the form of data points. Data points may include a current value or, in particular, an old/previous value, and/or, for example, a change indicator.

Input and/or output change notifications may be edited or created and sent when a corresponding input value has changed or when a changed value is to be passed to an output and made available there.

This may occur if a value of a data point (in both cases, i.e., in the input and/or output process image) has changed in such a way that an old/previous value no longer matches a new value. However, this may also occur if the new value matches an old/previous value, in particular after multiple changes. In particular, the change indicator makes it possible to technically implement the latter variant. This overcomes other alluded to disadvantages of the state of the art.

Several automation devices may also be combined, for example by interconnecting logical signals from different automation devices.

The control program may, for example, derive an output process image (output-side data points) from an input process image (input-side data points). If the control program changes a value in the output process image but then resets it to an original value, this interim change may be traced via the corresponding change indicator in the output process image. In the case of several successive changes, an original value may also be an intermediate value, i.e., a value adopted in the meantime. In particular, however, this may be its (i.e., “the”) original value. In particular, this may be a value that existed for the data point in question at a time when the control program was started, in particular last started. Such a start may also involve starting only a partial execution of the control program. Further details of these example of the invention will be understood in more detail from the description of the figures.

In another aspect of the present invention, a data processing apparatus is provided. The apparatus comprises components for carrying out the method according to any one of the aspects disclosed herein. The apparatus may be a data processing apparatus which is assigned to a user, like a client, and may be configured to carry out the corresponding steps. The apparatus may be a data processing apparatus which is assigned to a cloud computing environment, like a server, and may be configured to carry out the corresponding steps.

In another aspect of the present invention, a computer program is provided. The computer program comprises instructions which, when executed by a computer, cause the computer to carry out the method according to any of the aspects disclosed herein.

Although some aspects have been described with regard to an apparatus, it is clear that these aspects also represent a description of the corresponding method, wherein a block or an apparatus corresponds to a method step or a function of a method step. Analogously, aspects described with regard to a method step also represent a description of a corresponding block or element or a property of a corresponding apparatus.

Examples of the invention may be implemented in a computer system. The computer system may be a local computing device (e.g., personal computer, laptop, tablet computer, or mobile phone) having one or more processors and one or more storage devices, or may be a distributed computing system (e.g., a cloud computing system having one or more processors or one or more storage devices distributed across different locations, for example, a local client and/or one or more remote server farms and/or data centers). The computer system may include any circuit or combination of circuits. In an example, the computer system may include one or more processors, which may be of any type. As used herein, processor may mean any type of computing circuit, such as, but not limited to, a microprocessor, a microcontroller, a complex instruction set microprocessor (CISC), a reduced instruction set microprocessor (RISC), a very long instruction word (VLIW) microprocessor, a graphics processor, a digital signal processor (DSP), a multi-core processor, a field-programmable gate array (FPGA), or any other type of processor or processing circuit. Other types of circuitry that may be included in the computer system may be a custom-built circuit, an application specific integrated circuit (ASIC), or the like, such as one or more circuits (e.g., a communications circuit) for use with wireless devices such as cellular phones, tablet computers, laptop computers, two-way radios, and similar electronic systems. The computer system may include one or more storage devices, which may include one or more storage elements suitable for the particular application, such as a main memory in the form of a random access memory (RAM), one or more hard disks, and/or one or more drives containing removable media, such as CDs, flash memory cards, DVDs and the like. The computer system may also include a display device, one or more speakers, and a keyboard and/or controller, which may include a mouse, trackball, touch screen, voice recognition device, or any other device that allows a system user to enter information into and receive information from the computer system.

Some or all of the method steps may be carried out by (or using) a hardware device, such as a processor, a microprocessor, a programmable computer, or an electronic circuit. In an example, one or more of the key method steps may be carried out by such a device.

Depending on particular implementation requirements, examples of the invention may be implemented in hardware or software. The implementation may be carried out with a non-volatile storage medium such as a digital storage medium such as a floppy disk, a DVD, a Blu-Ray, a CD, a ROM, a PROM and EPROM, an EEPROM or a FLASH memory on which electronically readable control signals are stored that interact (or may interact) with a programmable computer system to carry out the respective method. Therefore, the digital storage medium may be computer-readable.

The invention may comprise a data carrier with electronically readable control signals that may interact with a programmable computer system such that one of the methods described herein is carried out.

In general, examples of the present invention may be implemented as a computer program product having a program code, wherein the program code is effective for carrying out one of the methods when the computer program product is running on a computer. The program code may, for example, be stored on a machine-readable medium.

Further examples include the computer program for carrying out one of the methods described herein, which is stored on a machine-readable data carrier.

In other words, an example of the present invention is thus a computer program with a program code for carrying out one of the methods described herein when the computer program runs on a computer.

An example of the present invention is therefore a storage medium (or a data carrier or a computer-readable medium) comprising a computer program stored thereon for carrying out any of the methods described herein when executed by a processor. The data carrier, the digital storage medium or the recorded medium are usually tangible and/or not seamless. A further example of the present invention is an apparatus as described herein comprising a processor and the storage medium.

An example of the invention is therefore a data stream or a signal sequence representing the computer program for carrying out one of the methods described herein. For example, the data stream or signal sequence may be configured to be transmitted over a data communication connection, for example over the Internet.

An example includes a processor, for example a computer or a programmable logic device, configured or adapted to perform any of the methods described herein.

An example comprises a computer on which the computer program for carrying out one of the methods described herein is installed.

An example of the invention comprises a device or system configured to transmit (e.g., electronically or optically) a computer program for carrying out one of the methods described herein, to a receiver. The receiver may be, for example, a computer, a mobile device, a storage device or the like. The device or system may, for example, comprise a file server for transmitting the computer program to the receiver.

In some examples, a programmable logic device (e.g., a field programmable gate array, FPGA) may be used to perform some or all of the functionality of the methods described herein. In examples, a field programmable gate array may cooperate with a microprocessor to perform any of the methods described herein. In general, the methods are preferably carried out by each hardware device.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary system, in particular for building automation, in which an example of the present invention may be deployed;

FIG. 2 shows an initial state with no unprocessed changes, according to an example of the present invention;

FIG. 3 shows a state associated with a message from DP1, according to an example of the present invention;

FIG. 4 shows a state with a trigger/request for executing the control program, according to an example of the present invention;

FIG. 5 shows an execution of affected instructions of a control program, according to an example of the present invention;

FIG. 6 shows an illustration of describing an exemplary output data point, according to an example of the present invention;

FIG. 7 shows resetting a change indicator (changed flag) in an input process image, according to an example of the present invention;

FIG. 8 shows an exemplary transmission of changed output data to the outputs, according to an example of the present invention;

FIG. 9 shows a state after changing an output data point, according to an example of the present invention; and

FIG. 10 shows an initial state with no unprocessed changes, according to an example of the present invention.

### DETAILED DESCRIPTION

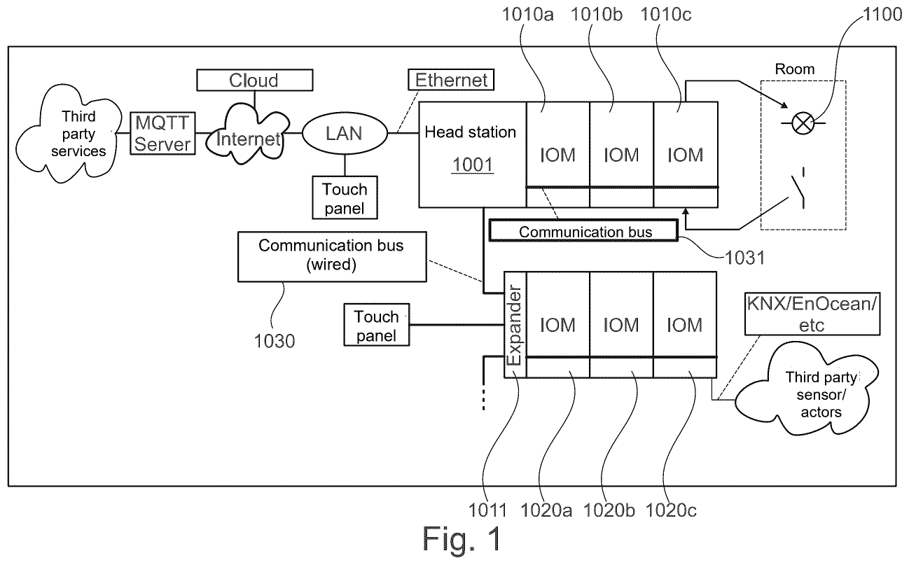

FIG. 1 shows an exemplary system in which an example of the present invention may be deployed.

There is shown an exemplary infrastructure which allows, for example, to automate and/or remotely control elements of a room, a floor and/or a building. The system comprises one or more head stations 1001 and input/output modules (IOMs) 1010a-c, which are arranged next to one another, for example, on a mounting rail. A communication between these elements may occur via a suitable communication bus 1031. Furthermore, the system comprises expanders 1011. The expanders may group multiple IOMs 1020a-c. The expanders 1011 (including their associated IOMs) may in particular be located at physically separate locations, in particular with respect to the head station 1001, with which they may communicate via a communication bus, in particular a wired communication bus 1030.

For example, buttons, switches, sensors, sockets, lamps 1100 and/or actuators 1100 may be connected to the IOMs 1010a-c, 1020a-c (the depicted number of three IOMs each being merely exemplary and in no way limiting) and thus controlled by the system. The IOMs thus form an interface to the field.

The IOMs 1010a-c, 1020a-c may be provided with local control capabilities. These local control capabilities enable, for example, switching operations and functions that only involve sensors and actuators connected to the IOM 1010a-c, 1020a-c to be controlled autonomously by the IOM 1010a-c, 1020a-c without requiring interaction with the rest of the system. This reduces the system's own energy consumption and increases availability, because the functions implemented by the IOMs 1010a-c, 1020a-c are available independently and reliably even in the event of a fault in other parts of the system (e.g., a failure of the head station).

The head station 1001 (or in part the local expander 1011) is responsible for functions that cannot be implemented locally by a single IOM 1010a-c, 1020a-c . In contrast to conventional systems, there is no cyclical/periodically recurring communication between head station 1001 (or local expander 1011) and IOMs 1010a-c, 1020a-c. Instead, communication only occurs when an event has occurred that requires involvement of the head station 1001/the expander 1011. During periods when no events occur and no communication takes place in the system, all components are in a power saving mode.

Especially with the IOMs 1010a-c, 1020a-c, this may lead to an almost complete shutdown of the component, which helps to enormously reduce the energy consumption in numerous application situations.

Further optimizations to reduce energy consumption may also be pursued.

For example, the head station 1001 (or the expander 1011) may be configured to differentiate in which communication bus segment there are changes and to wake up and query only these IOMs 1010a-c, 1020a-c from the energy saving mode. IOMs 1010a-c, 1020a-c in segments not affected by the event may remain undisturbed in power saving mode.

Furthermore, it may be envisaged that when writing back changed output data to the IOMs 1010a-c, 1020a-c, only those IOMs 1010a-c, 1020a-c are woken up from the energy saving mode whose outputs actually need to be updated.

The user does configure but not program the system. This may be done via a graphical user interface.

Preferably, simple control programs are used, for example as an executable end result of a corresponding configuration, which include instructions of the type “if X then do Y” (or are composed exclusively of them). Independence/permutability between the individual instructions of a control program may also be ensured. For example, the program may be executed with a deterministic result, wherein the execution order of the individual instructions does not matter (or alternatively is or needs to be only partially restricted). This allows for flexibility in execution and parallelization.

These and further optimizations contribute to the system's low energy requirements and energy consumption.

In addition to implementing IOM-wide functions, the head station 1001 may also be configured as a gateway to the “outside world”.

The head station 1001 may establish a connection to a cloud service and obtain the configuration for the system from it and distribute it to itself and to the IOMs 1010a-c, 1020a-c.

Furthermore, the head station 1010a-c, 1020a-c stores the complete configuration persistently in the head station to enable the replacement of a defective IOM even without a connection to the cloud.

Furthermore, the IOMs 1010a-c, 1020a-c also persistently store their configuration in order to be able to provide the locally implemented IOM functions even in case of an interruption of the electrical power supply (power failure) in the event of a fault (e.g. failure of the head station 1001). The head station 1001 may establish a connection to a (e.g. WAGO) server (which may be part of the cloud) and regularly receive firmware updates for itself and the components of the system. In return, the head station 1001 may be configured to upload logs (reports/error logs) with error and crash reports in the event of an error.

The head station 1001 preferably provides for a connection to an MQTT server for the exchange and interaction with third-party services, systems and devices.

It is also possible to connect the 1001 head station to proprietary and/or open standards (e.g. MATTER).

The system is quite energy-efficient, decentralized, autonomous and self-sufficient and, as a result, extremely robust.

A communication bus may be a wired communication bus, in particular a backplane bus on a DIN rail. The communication bus may allow for a serial connection with a transfer rate of, for example, 250 kbit/s.

A communication bus may alternatively or additionally be a wireless communication bus, in particular provided by an RS-485 connection (for example with 250 kbit/s). The electromagnetic compatibility is ideal for the desired robustness of the system. In addition to the data connection, a supply voltage for the remote device may also be transmitted optionally.

A 4-wire cable, such as that used in a KNX field bus, has proven to be particularly suitable for a wired communication bus.

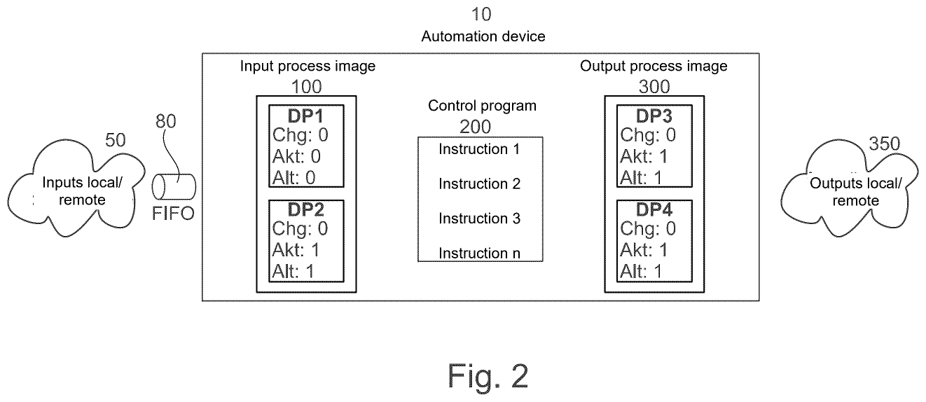

FIG. 2 shows an initial state without any unprocessed changes, according to an example of the present invention. An automation device 10 comprises an input process image 100, a control program 200 and an output process image 300. Local and/or remote inputs 50 may be provided on the input side, and corresponding local and/or remote outputs 350 may be provided on the output side. These inputs and outputs may be part of the local inputs and outputs of the automation device, or, for example, of remote I/O modules which are connected, for example, via a communication bus.

Two exemplary data points DP1, DP2 are shown in the input process image 100. For each data point, they may include a current value (Akt), an old and/or previous value (Alt) and a change indicator (Chg=change flag).

The output process image 300 may be structured and designed similarly.

FIG. 2 shows a state without unprocessed changes: the current and the previous value agree in the respective data point DP1 and DP2. The change flag Chg is also set to 0, i.e., the change indicator is not set. More complex change indicators are conceivable. In an exemplary (in this case Boolean) change indicator, the semantic meaning of 0 and 1 may also be swapped without thereby departing from the subject matter of the invention.

A FIFO module 80 is, as will become clearer later, a particularly suitable buffer in connection with the present invention, in particular an input-side buffer for change notifications.

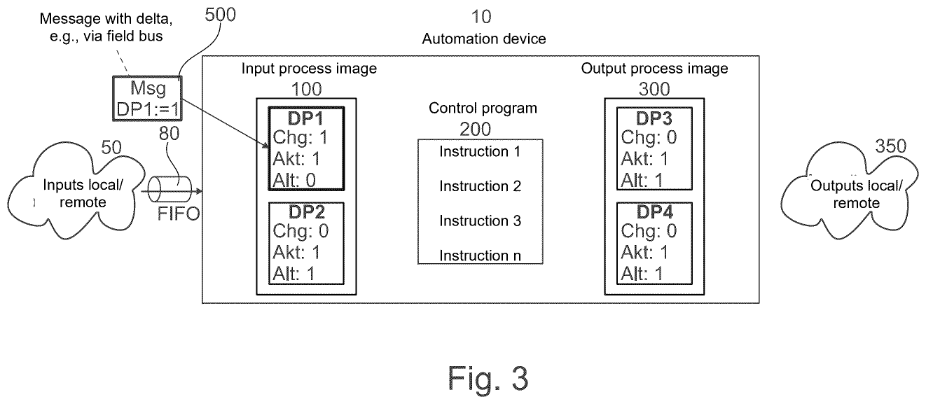

FIG. 3 shows what may happen in an example of the invention when the value of an input changes. The change is reported to the automation device 10 via, for example, a local or field bus. With this, a corresponding change notification 500 may be generated and transmitted. The change notification may be temporarily stored in the FIFO module 80, which may be part of the automation device 10 that processes the change notification 500. During processing, the current value (Akt) of the affected data point (here DP1) is updated and the change indicator is set to indicate the presence of a change (here: the change flag is set).

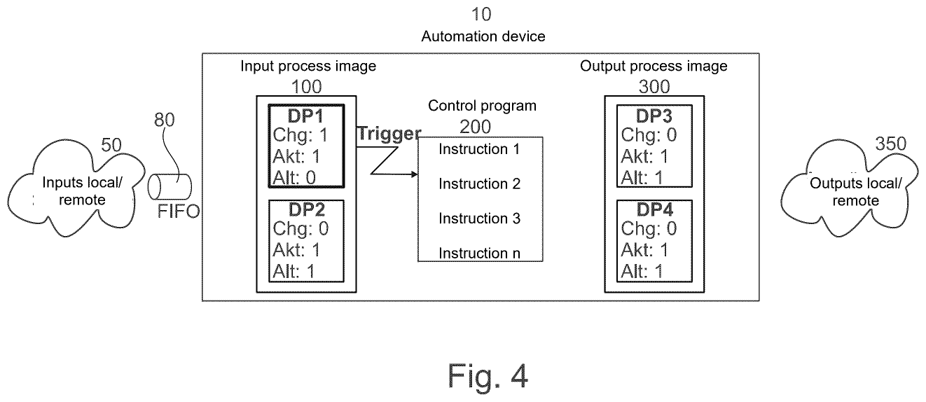

Subsequently, as shown in FIG. 4, the execution of the control program is triggered. There may be a short period of time between the request to execute the control program and the actual execution. Additional change notifications received during this period may be temporarily stored in the FIFO module 80. Change notifications 500 in the FIFO module 80 are entered message by message in the input process image 100 until the processing or start of an execution of the control program 200 actually begins.

In a special case-explained in the example shown here-it may happen that the value of the data point DP1 is changed back to ‘0’ due to another change at the input. In this case, the current value of DP1 would match the old value again, but the change indicator (Chg) of DP1 would remain set, indicating that there has been more than one change in the meantime. In particular, the information that there has been a change is retained for the subsequent data processing. In examples, additional information may be retained, in particular in the context of a change indicator which is, for example, a change counter.

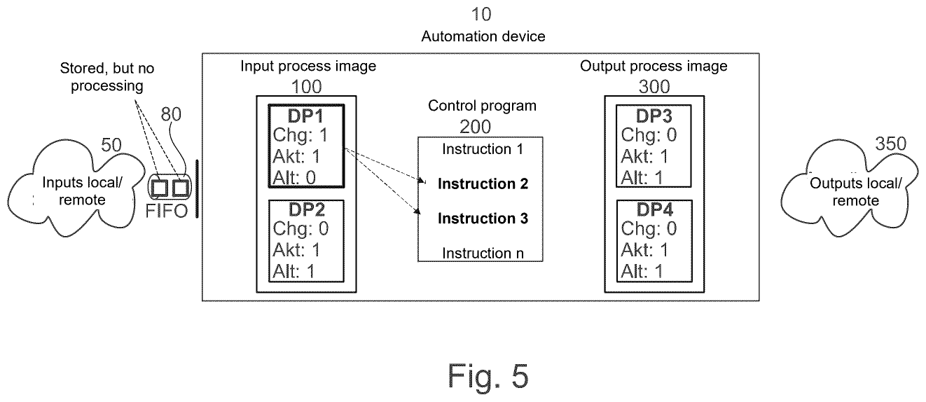

FIG. 5 shows the processing of affected instructions of the control program 200. In this case, only instructions of the control program 200 are executed for which the changed data points (here: only DP1) are quantities that are to be processed (here, for example, instructions 2 and 3). The remaining instructions of the control program 200 do not have to (or should not) be executed.

Change notifications received during the (partial) execution of the control program 200 are also buffered in the FIFO module 80 as usual. However, for example, no change notifications are transferred from the FIFO module 80 to the input process image 100.

When executing instructions of the control program 200, it may happen that data points are written to the output process image 300. However, the change flag is only set if the current value of the data point actually changes. This allows saving resources with regard to dependent subsequent processes, in particular in other modules and/or automation devices 10, but also in the output-side data transmission (bandwidth of the output-side communication bus).

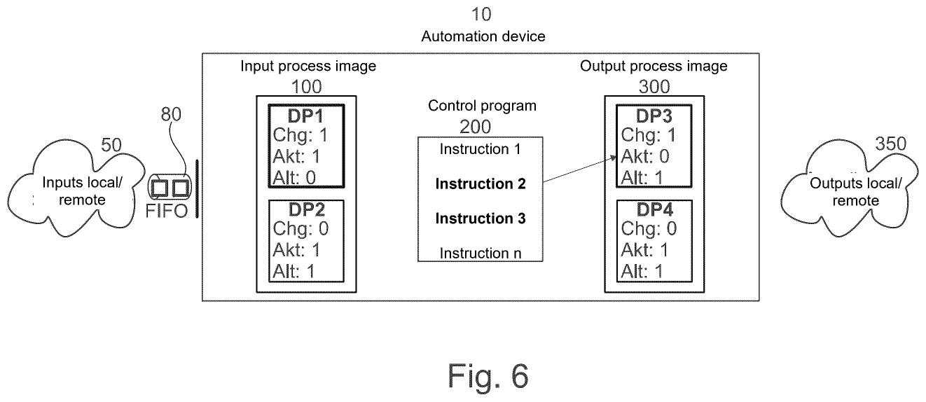

Such setting of the change indicator at the exemplary data point DP3 of the output process image 300 is shown in FIG. 6. Similar to the input data, it may also happen that a data point in the output image 300 is reset by another executed instruction before the processing of the control program 200 is completed. For example, DP3 could be written with ‘1’ by instruction 3, so that the current value of DP3 again matches the old value of DP3. However, the change flag of DP3 would remain set, indicating that there has been more than one change in the meantime. Here, too, further options to put into practice and/or improvements of the change indicator are conceivable, for example in the form of a change counter.

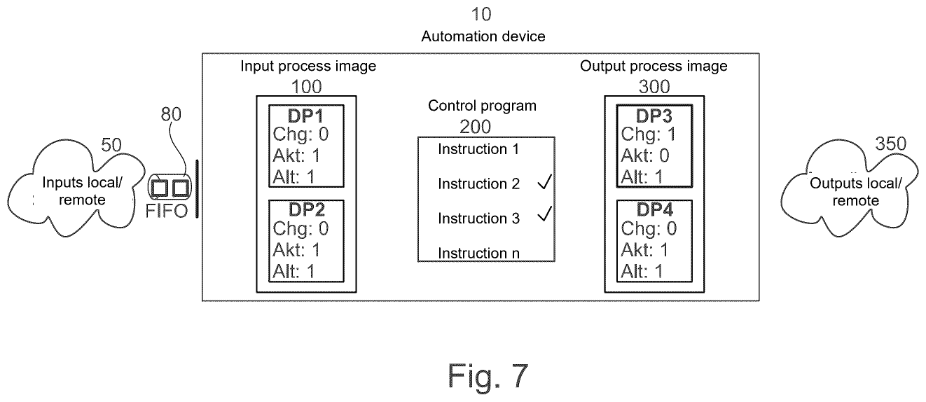

FIG. 7 illustrates resetting the change indicators in the input process image 100. After all instructions of the control program affected by DP1 have been processed, the change flag of DP1 may, for example, be reset and the old value of DP1 may be set to the new value.

This completes the processing of the control program.

If new change notifications 500 have accumulated in the FIFO module 80 in the meantime, they are entered into the input process image 100. For example, the execution of the control program 200 may be requested only when all change notifications 500 that have accumulated in the meantime have been entered into the input process image 100. However, change notifications 500 accumulated after the execution of the control program 200 may not delay the execution of the control program 200. The process may then be continued, for example, with FIG. 4.

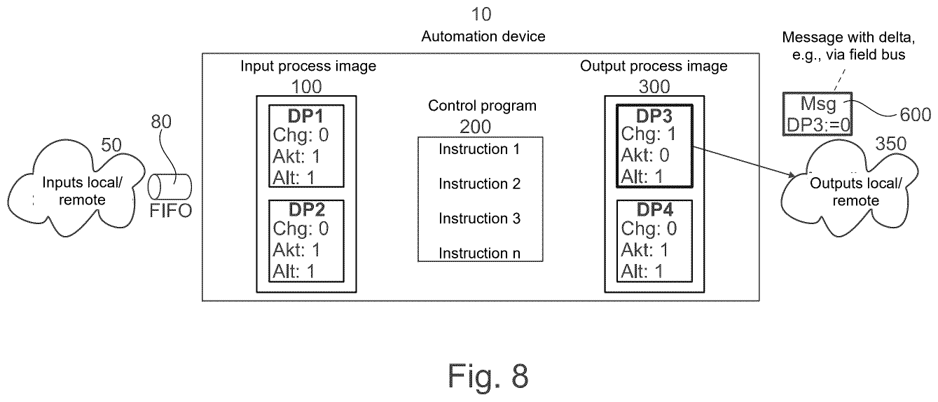

As illustrated in FIG. 8, during periods in which the control program 200 is not being processed, changed data points in the output process image 300 can be communicated to outputs via the field bus or local bus. As soon as such an outgoing change notification 600 has been sent, the change flag of the output data point (here DP3) can be reset, and the old value (Alt) can be set to the new value (Akt).

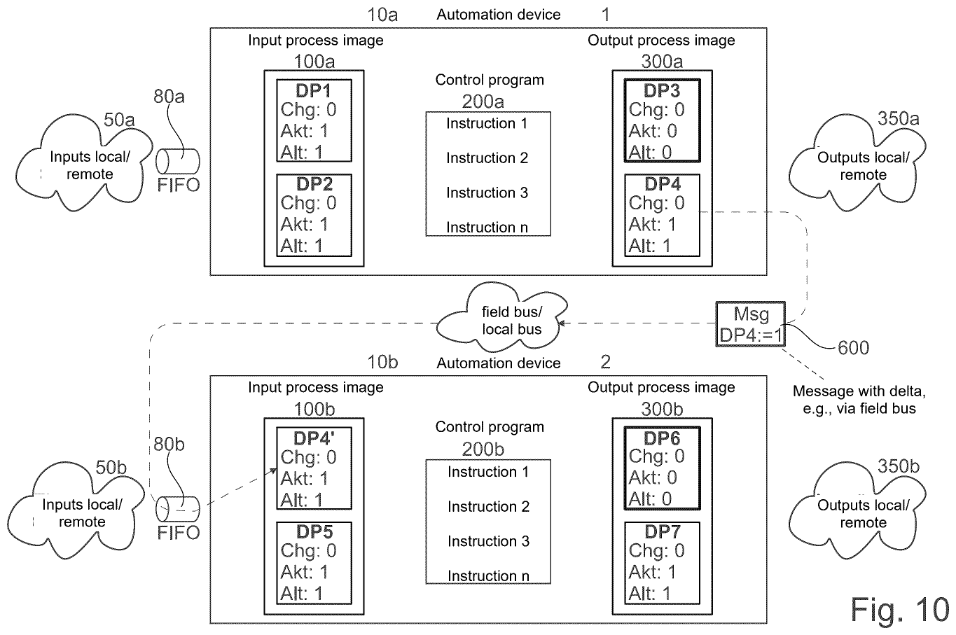

According to an example, a change notification 600 may also be sent if the old and current value of an output data point do not differ, but the change flag of the data point is set. In this case, the remote device would be informed that the value of the data point has changed multiple times, and the remote device has not seen all of the changes. This information is particularly relevant if the remote device is not an IO module but another automation device (see also FIG. 10).

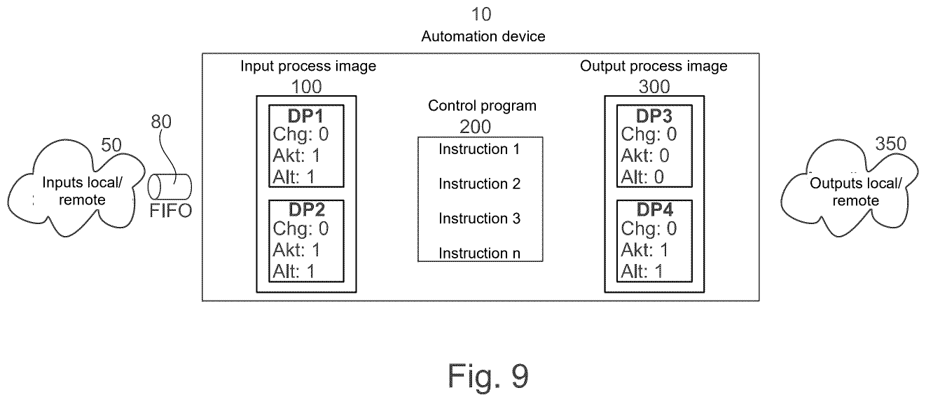

FIG. 9 illustrates the state of an automation device 10 after a transmission of a change of an output data point.

FIG. 10 illustrates another example of the present invention. Therein, two or more automation devices may be coupled. For example, a data point in the output process image of the first automation device no longer represents the state of an output of an input/output module (IOM) but represents the state of a data point in the input image of a second automation device. In FIG. 8, an outgoing message/change notification 600 is/was sent via the field or local bus, for example to an IOM 1010a-c, 1020a-c, as soon as the corresponding data point in the output image of the automation device has changed. The output of the IOM 1010a-c, 1020a-c was then set to the new value.

In FIG. 10, the message/change notification 600 originating from the first automation device 10a is/was not sent to an IOM 1010a-c, 1020a-c, but to a second automation device 10b, where it updates a data point in the input process image. The change of the data point may then call for/cause the execution of the control program in the second automation device 10b. The process in the second automation device 10b would then be as shown in/starting from FIG. 4. For the second automation device 10b, it makes no difference whether the data point in the input image 100b represents the state of an input of an IOM 1010a-c, 1020a-c or the state of an output data point in the output process image 300a of the first automation device 10a.

If, for example, DP4 changes twice so that the current and the old value match again, a change notification 600 is still transmitted to the second automation device 10b because the change indicator of DP4, here provided by the change flag (Chg=1), is set accordingly. According to an example, such a change notification does not have to contain any usable value (Akt/Alt): the transmission of the corresponding change indicator/change flag may be sufficient.

In DP4′, the current value will not change, but DP4″s own change indicator will be set. This indicates that there has been more than one change in the meantime.

In this way, important events such as “light switch pressed” cannot be lost, even if the value of the data point changes several times before it is evaluated by the control program.

A special form of the data points may be that a change counter which, for example, counts the number of changes, is provided as change indicator instead of the change flag. In this case, not only the information that an event has occurred would be available, but also the number of “unseen” events, which are thus de facto preserved and cannot be lost.

The depicted illustrations of the examples show data points whose values have the type BOOL (true/false, 1/0). True and false can be semantically swapped; such a swap is conceivable for both the data points and the change indicators. However, any other data types for change indicators are also conceivable, in particular for the values of the data points, especially those that represent a number, e.g., an analog value. In this case, it may be advantageous if the data point includes the minimum and maximum values in addition to the old and current values. For an input data point, these two values indicate the range in which the current value has moved/changed since the data point was last processed by the control program. For an output data point, the two values indicate the range in which the current value has moved since the associated output was last updated with the data point and/or the value was last communicated to another automation device.

For data points of the type BOOL, the change flag was used as a trigger for processing by the control program or for forwarding the data point to the IO module or to the second automation device. For data points with other data types and minimum and maximum values, it may be advantageous to use the deviation of the minimum or maximum value from the old value instead of the change flag. In this way, the processing of the control program or the forwarding to an IO module may be suppressed if the value has changed only very slightly (e.g., due to noise), for instance by less than a predefined value (tolerance/threshold). This increases efficiency. This again reinforces the paradigm of resource conservation in the field by the present invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for event-based operation of a programmable automation device, the method comprising:
receiving a change notification indicating a changed value of an input of the automation device;
updating a data point of an input process image of the automation device, which is assigned to the input, based on the changed value; and
setting a change indicator of the data point of the input process image, which indicates that the data point has been updated.

2. The method of claim 1, further comprising:
initiating an at least partial execution of a control program of the automation device only if the change indicator is set for at least one data point of the input process image.

3. The method of claim 2, wherein execution is initiated only for those instructions of the control program which comprise the updated data point and/or which comprise further data points, which are dependent on the data point, as input variable.

4. The method of claim 2, wherein the change notification is a first change notification indicating a change of the input from a previous value to the changed value, and wherein the method further comprises:
receiving a second change notification prior to the at least partial execution of the control program, the second change notification indicating that the value of the input is again equal to the previous value;
updating the data point of the input process image of the automation device, which is assigned to the input, based on the previous value; and
leaving the change indicator of the data point of the input process image set to indicate that the data point has been updated.

5. The method of claim 2, further comprising:
receiving a further change notification during the at least partial execution of the control program, wherein the further change notification indicates a changed value of an input of the automation device; and
updating a data point of the input process image of the automation device, which is assigned to the input, based on the changed value only when the at least partial execution of the control program is completed.

6. The method of claim 2, wherein by at least partially executing the control program at least one data point of an output process image of the automation device which is assigned to an output of the automation device is updated, and wherein the method further comprises:
setting a change indicator of the data point of the output process image, which indicates that the data point has been updated.

7. The method according to claim 6, wherein the change indicator is only set if the value of the data point changes as a result of updating the data point.

8. The method according to claim 6, wherein before a possible completion of the at least partial execution of the control program, the value of the data point is reset to an original or exactly its original, value, and wherein the method further comprises:
leaving the change indicator of the data point of the output process image set to indicate that the data point has been updated.

9. The method of claim 2, further comprising:
resetting the change indicator of the data point of the input process image after the at least partial execution of the control program has been completed.

10. The method of claim 6, further comprising:
generating a change notification which indicates at least one changed value of at least one output of the automation device after the at least partial execution of the control program has been completed; and
resetting the change indicator of the at least one data point of the output process image.

11. An automation device configured to carry out the method according to claim 1.

12. An automation system, a non-time-critical automation system, or a building automation system, which comprises at least one automation device of claim 11.

13. A computer program or a computer-readable medium on which the computer program is stored, wherein the computer program comprises instructions which cause an automation device to carry out the method according to claim 1.
